(19) United States
(12) Patent Application Publication
(10) Pub. No.: US 2010/0255222 A1
(43) Pub. Date: Oct. 7, 2010

(54) DISPLAY ELEMENT

(75) Inventors: Shinichi Hirato, Osaka-shi (JP); Iichiro Inoue, Osaka-shi (JP); Ryoh Ueda, Osaka-shi (JP); Hiroyuki Hakoi, Osaka-shi (JP); Koichi Miyachi, Osaka-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi, Osaka (JP)

(21) Appl. No.: 12/746,217

(22) PCT Filed: Aug. 20, 2008
(86) PCT No.: PCT/JP2008/064786

§ 371 Date: Jun. 18, 2010

(30) Foreign Application Priority Data
Dec. 5, 2007 (JP) 2007-314549

(51) Int. Cl. B32B 3/10; C09K 19/02; B32B 38/14

(52) U.S. Cl. 428/1.26; 428/195.1; 156/182

(57) ABSTRACT

A display element that includes substrates each having a thin film layer formed by applying a thin film layer composition thereon by an ink-jet method, in which, in the formation of the thin film layers, streaky display unevenness does not develop along a direction in which an ink-jet head discharges the composition having the shape of dots aligned on straight lines from the nozzles. In the liquid crystal display element 1 including an array substrate 5 including an alignment film 8, and a color filter substrate 3 including an alignment film 7, the substrates 5 and 3 being used in a pair, the dots on the alignment films 7 and 8 are aligned such that an interval between the straight lines on the alignment film 8 is displaced by half an interval from an interval between the straight lines on the alignment film 7.

### BACKGROUND OF THE INVENTION

1. Field of the Invention

The present invention relates to a display element that includes substrates each having a thin film layer formed thereon by an ink-jet method, and specifically relates to a display element favorably used for a liquid crystal display element that includes substrates each having a thin film layer including an alignment film formed thereon by an ink-jet method.

2. Description of the Related Art

In recent years, liquid crystal display elements are in widespread use as display elements of television receivers. For example, a liquid crystal display element used in a television receiver has a configuration such that a liquid crystal is sealed in between a pair of transparent substrates such as an array substrate and a color filter substrate, and an alignment film made from a polyimide is formed in an entire effective picture area on a surface of each transparent substrate, the surfaces being in contact with the liquid crystal. A known method for forming such an alignment film using an ink-jet method is disclosed in Japanese Patent Publication Laid-Open No. 2001-42330.

In addition, for the purpose of forming an alignment film that has a uniform thickness by an ink-jet method, a known method for forming an alignment film is used in which an alignment film material is discharged from an ink-jet head that includes a plurality of nozzles aligned at a given pitch such that adjacent dots of the discharged alignment film material applied on a substrate overlap one another, which is disclosed in Japanese Patent Publication Laid-Open No. 2005-221890.

In addition, for the purpose of minimizing display unevenness of a liquid crystal display panel that results from nonuniform thickness of an alignment film formed by an ink-jet method, a known method for discharging droplets that form an alignment film onto a substrate is used in which a moving direction of an ink-jet head relative to the substrate is inclined at a given angle with respect to array directions of pixels arranged in a matrix on the substrate, which is disclosed in Japanese Patent Publication Laid-Open No. 2006-320839.

In applying a composition of an alignment film on a substrate by an ink-jet method, an ink-jet head that includes a plurality of aligned nozzles is used, and while discharging the alignment film composition onto the substrate from the nozzles, the ink-jet head is moved in a direction in which the ink-jet head discharges the composition having the shape of dots aligned on straight lines from the nozzles. During this application process, the alignment film composition is discharged onto the substrate from the plurality of aligned nozzles at the same time, and the ink-jet head is moved in the discharging direction, discharging the composition at a given interval. Droplets of the alignment film composition discharged from the nozzles reach a surface of the substrate and spread out to form a uniform film thereon.

However, in the case of the application of the alignment film composition by the ink-jet method, there might arise a problem that streaky display unevenness develops along the discharging direction of the ink-jet head in the liquid crystal display element depending on the composition or the physical properties of the alignment film composition, or application conditions of the ink-jet head such as a pitch of the nozzles, a moving velocity and a discharge amount. This is assumed to be because of nonuniform thickness of the formed alignment film that results from the droplets of the alignment film composition that do not spread out uniformly in an aligned direction of the nozzles. The problem of display unevenness could arise in a display element not only in a case where an alignment film is formed on an entire substrate by an ink-jet method, but also in a case where a thin film layer is formed on an entire substrate by an ink-jet method and the formed thin film layer has a nonuniform thickness.

### SUMMARY OF THE INVENTION

An object of the invention is to overcome the problems described above and to provide a display element that includes substrates each having a thin film layer formed by applying a thin film layer composition thereon by an ink-jet method, in which, in the formation of the thin film layers, streaky display unevenness does not develop along a direction in which an ink-jet head discharges the composition having the shape of dots aligned on straight lines from the nozzles.

In order to overcome the problems described above, preferred embodiments of the present invention provide a display element that includes a first substrate including a first thin film layer including a thin film layer composition having the shape of dots aligned on straight lines, and a second substrate including a second thin film layer including a thin film layer composition having the shape of dots aligned on straight lines, the second substrate being paired with the first substrate, the dots on the first and second thin film layers being aligned such that an interval between the straight lines on one of the first and second thin film layers is displaced by half an interval from an interval between the straight lines on the other thin film layer, the thin film layer compositions having the dot shape being applied on surfaces of the first and second substrates by an ink-jet method for applying a thin film layer composition on a surface of a substrate, with the use of an ink-jet head that includes a plurality of nozzles aligned at a given pitch in an aligned-nozzle direction capable of discharging the thin film layer composition at a time, while the ink-jet head is moved above the substrate in a direction in which the ink-jet head discharges the composition from the nozzles.

In the display element, it is preferable that the first and second thin film layers are formed such that after the application of the composition while the ink-jet head is moved in the discharging direction, the ink-jet head is shifted in the aligned-nozzle direction, the ink-jet head is moved in the discharging direction through another location above the substrate, and the thin film layer composition is reapplied on the substrate surface, or that the first and second thin film layers are formed such that a distance of the shift of the ink-jet head is set to be smaller than the interval between the straight lines, and the thin film layer composition is applied between the interval, while the nozzles of the ink-jet head are moved in the discharging direction while being shifted in the aligned-nozzle direction between the interval on the substrate surface.

In the display element, it is preferable that the first and second thin film layers are each formed such that the ink-jet head is moved in the discharging direction a plurality of times through a same location, and the dots of the composition on each straight line overlap each other, or that the discharging direction of the ink-jet head includes a direction perpendicular to the aligned-nozzle direction.

In the display element, it is preferable that the first thin film layer and the second thin film layer are formed with the use of the identical ink-jet head, or that one of the first thin film layer and the second thin film layer includes bus lines for matrix driving including data lines and scanning lines, the bus lines being disposed at a given interval.

In the display element, it is preferable that the discharging direction of the ink-jet head includes a direction parallel to the bus lines, or that the bus lines include the scanning lines.

In the display element, it is preferable that one of the first thin film layer and the second thin film layer includes a black matrix aligned at a given interval, that the first thin film layer and the second thin film layer each include an alignment film and the first substrate and the second substrate are disposed having the alignment films opposed to each other, that one of the first thin film layer and the second thin film layer includes a resin including a polyimide, that the first thin film layer includes an array substrate and the second thin film layer includes a color filter substrate, or that the display element includes a liquid crystal display element that includes a liquid crystal that is sealed in between the first and second substrates.

It is to be noted that in the preferred embodiments of the present invention, the movement in the discharging direction and the shift in the aligned-nozzle direction define relative movement between the nozzles and the substrates. That is, in performing the movement in the discharging direction and the shift in the aligned-nozzle direction, either the nozzles or the substrates may be moved, and it is essential only that the ink-jet head (the nozzles) should be moved relatively on the substrates.

Since the display element according to the preferred embodiments of the present invention includes the pair of first and second substrates including the first thin film layer and the second thin film layer respectively that are formed by applying the thin film layer compositions on the substrates by the ink-jet method, the first and second thin film layers each sometimes have a nonuniform thickness in the aligned-nozzle direction depending on the composition or the physical properties of the thin film layer compositions, or application conditions. The thin film layers have identical shapes such that the layers are largest in thickness at locations immediately below the nozzles of the ink-jet head, and smallest in thickness at locations below the midpoints between the nozzles in the aligned-nozzle direction. This is because both the thin film layers are formed with the use of the identical ink-jet head having the nozzles aligned at the given pitch.

Since the dots on the first and second thin film layers are aligned such that the interval between the straight lines on one of the first and second thin film layers is displaced by half the interval from the interval between the straight lines on the other thin film layer, the nonuniform thickness of one of the first and second thin film layers is displaced by half the interval from the nonuniform thickness of the other thin film layer. In the display element including the pair of first and second substrates having the configurations described above, the nonuniform thickness of one of the first and second thin film layers is cancelled out by the nonuniform thickness of the other thin film layer, and thus the nonuniform thicknesses of the first and second substrates are cancelled each other out, which brings about a state as if there exists no nonuniform thickness. Hence, the nonuniform thicknesses do not influence the transmittance of the display element, and accordingly do not develop streaky display unevenness along the discharging direction. Thus, according to the preferred embodiments of the present invention, the display element has no streaky display unevenness developing along the discharging direction in the formation of the thin film layers.

### BRIEF DESCRIPTION OF THE DRAWINGS

FIG. 1 is a cross-sectional view showing one example of a relevant part of a liquid crystal display element.

FIG. 2A is an enlarged view showing a liquid crystal layer of the liquid crystal display element shown in FIG. 1, and FIG. 2B is an enlarged view showing another embodiment of the liquid crystal layer of the liquid crystal display element shown in FIG. 2A.

FIG. 3 is a schematic view for illustrating formation of an alignment film on a transparent substrate of an array substrate by an ink-jet method, the view being a cross-sectional view in an aligned direction of nozzles of an ink-jet head.

FIG. 4 is an overhead plan view showing the transparent substrate and the ink-jet head shown in FIG. 3.

FIG. 5 is a graph showing transmittance of the array substrate shown in FIG. 3.

FIG. 6A is a graph showing a wave of superimposed two waves, one of which being a wave having a cycle equal to a pitch between the nozzles, and the other being a wave having a cycle equal to an interval between pixels. FIG. 6B is a graph showing a wave of the superimposed two waves shown in FIG. 6A, where the wave having the cycle equal to the nozzle pitch is displaced by half a cycle in the horizontal axis (the axis indicating the distance).

FIG. 7 is a plan view for illustrating the alignment film of the array substrate and an alignment film of a color filter substrate, which shows the substrates and ink-jet head.

FIGS. 8A to 8E are views for illustrating a case of repeatedly applying a composition of the alignment film while shifting the ink-jet head in the aligned-nozzle direction.

FIG. 9 is a view for illustrating a case of repeatedly applying the alignment film composition.

FIGS. 10A to 10C are plan views showing other embodiments of the ink-jet head.

### DETAILED DESCRIPTION OF PREFERRED EMBODIMENTS

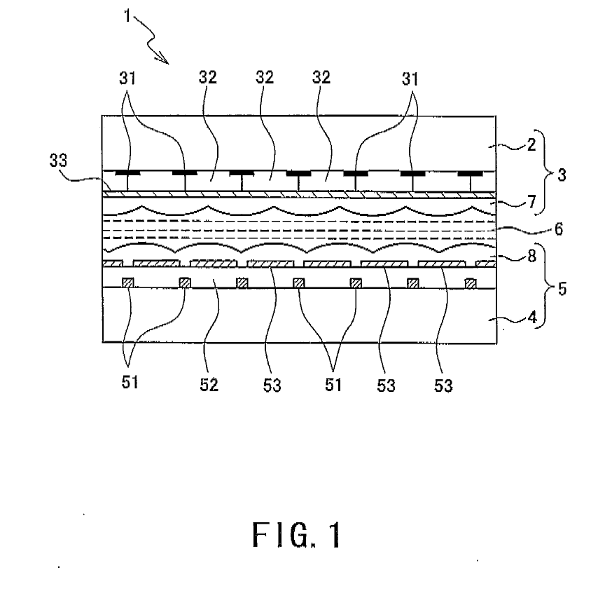

A detailed description of a display element according to preferred embodiments of the present invention will now be provided with reference to the accompanying drawings. In the preferred embodiments of the present invention, used as one example of the display element is an active matrix type TFT (Thin Film Transistor) liquid crystal display element including alignment films that define thin film layers formed by an ink-jet method. FIG. 1 is a cross-sectional view showing one example of a relevant part of the liquid crystal display element. In FIG. 1, a liquid crystal display element 1 includes a color filter substrate 3 (a first substrate) including a transparent substrate 2 on which a color filter is formed, an array substrate 5 (a second substrate) including a transparent substrate 4 on which TFTs are formed, and a liquid crystal layer 6 interposed between the substrates 3 and 5, in which a liquid crystal is sealed. The color filter substrate 3 includes an alignment film 7 (a first alignment film) formed on its surface in contact with the liquid crystal layer 6. The array substrate 5 includes an alignment film 8 (a second alignment film) formed on its surface in contact with the liquid crystal layer 6. In combining the color filter substrate 3 and the array substrate 5 to be used in a pair in the liquid crystal display element 1, the substrates 3 and 5 are stacked with the alignment film 7 and the alignment film 8 opposed to each other.

In the preferred embodiments of the present invention, the color filter substrate 3 is referred to as the first substrate and the array substrate 5 is referred to as the second substrate just for the sake of convenience, though either substrate may be referred to as a first substrate.

The liquid crystal display element 1 has a plane structure such that pixels are arranged in a matrix. In FIG. 1, the cross-sectional view partially shows the liquid crystal display element 1, where a number of pixels are shown. In the liquid crystal display element 1, the array substrate 5 includes pixel electrodes 53 on the transparent substrate 4, which are provided individually to the pixels and arranged in a matrix. In addition, the array substrate 5 includes bus lines consisting of scanning lines 51 and data lines (not shown) that are aligned perpendicular to each other so as to surround the pixel electrodes 53.

The color filter substrate 3 includes a black matrix 31, a color filter 32, a common electrode 33 and other components on the transparent substrate 2. The liquid crystal display element 1 includes optical sheets such as a polarizing plate, a diffusion sheet and a lens sheet, a protection film and other components (not shown), which are stacked on surfaces of the color filter substrate 3 and the array substrate 5, the surfaces being not in contact with the liquid crystal layer 6.

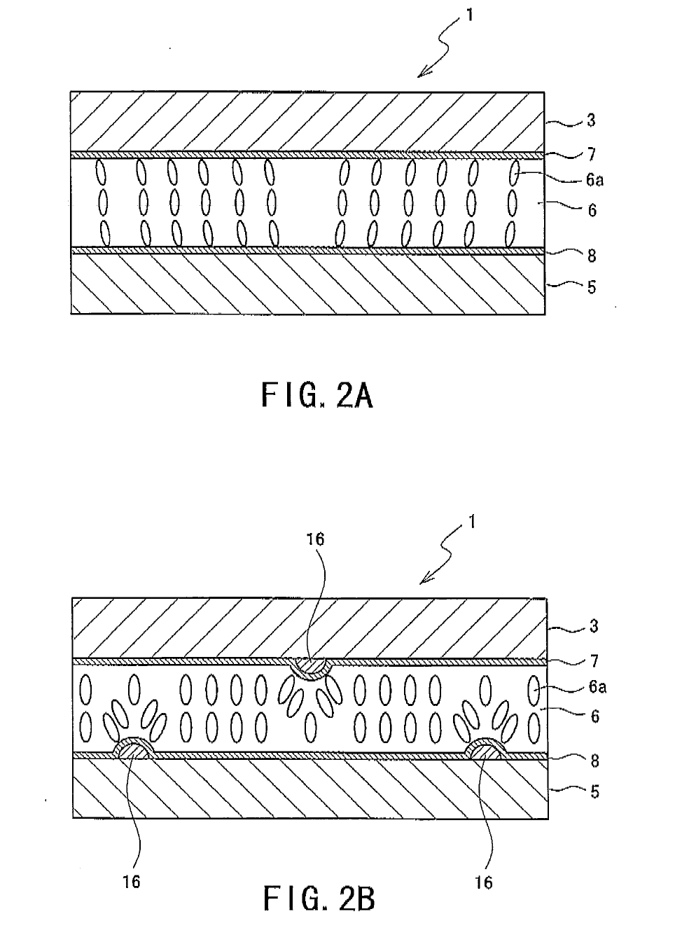

FIG. 2A is an enlarged view showing the liquid crystal layer 6 of the liquid crystal display element 1 shown in FIG. 1. As shown in FIG. 2A, the liquid crystal display element 1 defines a liquid crystal display element using a vertical alignment mode such that liquid crystal molecules 6a having negative dielectric anisotropy are used. It is to be noted that FIG. 2A is a view where projections and depressions on the alignment films 7 and 8 resulting from their nonuniform thicknesses, components such as the color filter, the pixel electrodes and spacers are not shown.

The alignment films 7 and 8 are each formed by applying an alignment film composition including a resin containing a polyimide by an ink-jet method using an ink-jet head, and the alignment films 7 and 8 define thin film layers. The alignment films 7 and 8 are each formed usually to have a thickness of about 10 to 100 nm. A solution prepared by dissolving or dispersing a polyimide in a solvent, or a solution prepared by dissolving or dispersing a polyamic acid in a solvent is used for the alignment film compositions.

Compared with an alignment film composition generally used in a printing method, the alignment film compositions used in the ink-jet method need to be less viscous by being reduced in concentration and viscosity so as to easily spread out immediately after reaching the substrate surfaces. However, since it is difficult for the alignment film compositions having reduced viscosity to be stably discharged, the alignment film compositions need to be viscous to some extent in order to be stably discharged in the ink-jet method. However, the alignment film compositions having increased viscosity do not easily spread out uniformly on the substrates after discharged thereonto. This is one factor why the alignment films have a nonuniform thickness, which will be described later.

In the formation of the alignment films 7 and 8, polyimide thin films are firstly formed by applying the alignment film compositions by the ink-jet method on the transparent substrates 2 and 4 on which the color filter, the TFTs, the electrodes and other components are formed, and subjecting the films to a provisional dry treatment to volatilize and dry the solvents, and then to a heat treatment using a baking furnace. The polyimide thin films have a characteristic of aligning liquid crystal molecules in a direction vertical to the substrate, the polyimide thin films develop anisotropy on their surfaces by being irradiated on the surfaces with light such as polarized ultraviolet light in a given direction. Thus, the alignment films 7 and 8 subjected to the alignment processing (photo-alignment processing) so as to align the liquid molecules in the given direction are formed.

It is also preferable that the liquid crystal display element 1 shown in FIG. 2A has the configuration shown in FIG. 2B. As shown in FIG. 2B, the liquid crystal display element 1 defines the liquid crystal display element using the vertical alignment mode such that the liquid crystal molecules 6a having the negative dielectric anisotropy are used. The liquid crystal display element 1 includes, on the array substrate 5 and the color filter substrate 3, ribs 16 (e.g., protrusions, protruding members, elevation changes) arranged to control the alignment of the liquid crystal molecules 6a in the liquid crystal layer 6, as shown in FIG. 2B. The alignment films 7 and 8 are formed over the ribs 16, and the ribs 16 form elevation changes on the alignment films 7 and 8. The alignment films 7 and 8 are made from a material having a characteristic of aligning the liquid crystal molecules 6a almost vertical to the surfaces of the alignment films 7 and 8. To be specific, a resin containing a polyimide in which a hydrophobic structure is introduced is preferably used as the material of the alignment films 7 and 8. It is to be noted that FIG. 2B is a view where projections and depressions on the alignment films 7 and 8 resulting from their nonuniform thicknesses, components such as the color filter, the pixel electrodes and spacers are not shown.

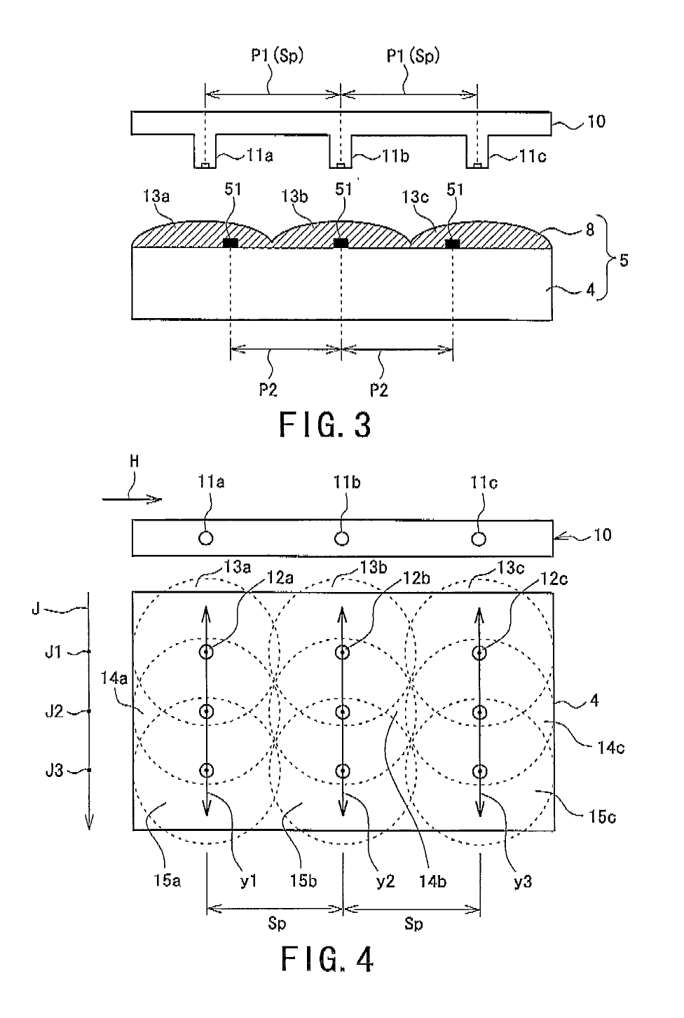

FIG. 3 is a schematic view for illustrating formation of the alignment film on the transparent substrate of the array substrate by the ink-jet method, the view being a cross-sectional view in an aligned direction of nozzles of an ink-jet head. FIG. 4 is an overhead plan view showing the transparent substrate and the ink-jet head shown in FIG. 3. FIGS. 3 and 4 are views showing a portion of the transparent substrate. As shown in FIG. 3, an ink-jet head 10 includes a plurality of ink-jet nozzles (hereinafter, sometimes referred to as nozzles) 11 (e.g., three ink-jet nozzles 11a, 11b and 11c) that are aligned at a pitch P1 and arranged to intermittently discharge the alignment film composition such that the alignment film composition reaches the surface of the transparent substrate 4 to form points there. When the alignment film composition is discharged from the nozzles 11 (11a, 11b and 11c) at a time, points 12 (12a, 12b and 12c) of the composition that correspond to the nozzles 11 are formed aligned on the surface of the transparent substrate 4, forming a line of the discharged composition. Then, the droplets 12 (12a, 12b and 12c) of the composition spread out in a horizontal direction to take the shape of dots 13 (13a, 13b and 13c).

The ink-jet head 10 is movable horizontal to the surface of the transparent substrate 4 in a desired direction while disposed at a given level above the substrate 4 maintaining a space therebetween. The ink-jet head 10 is arranged to move above the substrate 4 while intermittently discharging the alignment film composition from the nozzles 11a, 11b and 11c, and thereby the alignment film composition is applied on the entire surface of the substrate 4.

In the preferred embodiments of the present invention, the horizontal movement of the ink-jet head 10 in the direction in discharging the alignment film composition onto the substrate 4 is referred to as the “movement in the discharging direction”. The discharging movement is performed in a desired direction, for example, performed from one end of the substrate toward the other end. Examples of the discharging direction include a direction parallel to the vertical direction or the horizontal direction of the display element, a direction parallel to the lines of the pixels, and a direction not parallel to the vertical or horizontal direction of the display element nor parallel to the lines of the pixels. The amount of the movement in the discharging direction of the ink-jet head 10 is determined appropriately depending on the length, the width or other physical descriptions of the substrate 4.

The ink-jet head 10 is reciprocable in the discharging direction. Hence, performing the discharging movement several times by moving repeatedly in the discharging direction through the locations where the composition is already discharged, the ink-jet head 10 is capable of applying the composition on the substrate such that the composition overlaps.

Further, the ink-jet head 10 is movable in the aligned-nozzle direction. The movement in the aligned-nozzle direction of the ink-jet head 10 is referred to as the “shift in the aligned-nozzle direction”. The aligned-nozzle direction is perpendicular to the discharging direction. The amount of the shift in the aligned-nozzle direction of the ink-jet head 10 is determined appropriately depending on the length, the width or other physical descriptions of the substrate 4.

It is to be noted that in the preferred embodiments of the present invention, the movement of the ink-jet head 10 defines relative movement between the nozzles 11 and the substrate 4. That is, either the ink-jet head 10 or the substrate 4 may be moved.

The nozzles 11a, 11b and 11c are connected to a tank (not shown) that stores the alignment film composition to feed to the nozzles 11a, 11b and 11c. The ink-jet head 10 has a configuration such that the feed rate of feeding the alignment film composition to the nozzles 11, the interval and the amount at which the alignment film composition is discharged intermittently onto the substrate surface from the nozzles 11, and other conditions are arbitrarily controllable. The nozzles 11 are height adjustable, so that the space between the tips of the nozzles 11 and the substrate surface can be adjusted arbitrarily.

In the preferred embodiment of the present invention shown in FIGS. 3 and 4, the discharging direction of the ink-jet head 10 (indicated by the arrow J in FIG. 4) is parallel to the scanning lines 51 and defines the length direction of the substrate 4 while the aligned-nozzle direction of the ink-j et head 10 (indicated by the arrow H in FIG. 4) is perpendicular to the discharging direction and defines the width direction of the substrate 4. In applying the alignment film composition on the surface of the substrate 4, the ink-jet head 10 including the nozzles 11a, 11b and 11c is first moved by a given distance in the discharging direction J up to a location J1, and then discharges the alignment film composition at the location J1 onto the substrate surface from the nozzles 11a, 11b and 11c. The droplets of the alignment film composition are discharged from the nozzles 11a, 11b and 11c at a time, and form a line of the discharged composition in the lateral direction in FIG. 4 at the location J1, the line joining the points 12a, 12b and 12c corresponding to the nozzles 11a, 11b and 11c respectively.

The points 12 (12a, 12b and 12c) of the alignment film composition that are discharged from the tips of the nozzles 11a, 11b and 11c to reach the substrate surface spread out circularly around themselves if the substrate surface is smooth, and take the shape of the dots 13 (13a, 13b and 13c). If the substrate surface is not smooth, they spread out taking an irregular shape. The dots 13 (13a, 13b and 13c) of the alignment film composition are arranged such that the dots 13 discharged from the adjacent nozzles 11 overlap one another. A single discharge of the alignment film composition from the ink-jet head 10 forms a line joining the dots 13a, 13b and 13c in a direction parallel to the aligned-nozzle direction H.

The ink-jet head 10 is moved continuously in the discharging direction while discharging the alignment film composition at a location J2 and a location J3 onto the substrate surface from the nozzles 11a, 11b and 11c. In the same manner of the formation of the line joining the dots 13a, 13b and 13c at the location J1, a line of the discharged composition that joins dots 14 (14a, 14b and 14c) is formed at the location J2, and a line of the discharged composition that joins dots 15 (15a, 15b and 15c) is formed at the location J3. The dots 14 at the location J2 and the dots 15 at the location J3 are parallel to the dots 13 at the location J1. Thus, the lines joining the dots are formed successively at the respective locations in the discharging direction so as to have a given interval therebetween, and thereby the alignment film composition is applied on the substrate surface from one end of the substrate (the top of FIG. 4) to the other end (the bottom of FIG. 4).

In horizontally moving the ink-jet head 10 linearly in the discharging direction J while the alignment film composition is discharged onto the substrate surface from the nozzles 11 of the ink-jet head 10, the interval at which the alignment film composition is discharged is adjusted such that the dots 13 of the alignment film composition that are discharged from one of the nozzles 11 overlap one another also in the discharging direction J, and the discharge of the alignment film composition is performed. The dots 13 of the alignment film composition are joined linearly in the discharging direction J. As shown in FIG. 4, the dots 13, the dots 14, and the dots 15 overlap one another both in the aligned-nozzle direction H and the discharging direction J, and the film made from the alignment film composition is formed in a crisscross manner on the substrate surface.

As shown in FIG. 4, the distance that corresponds to the interval between a line y1 that joins the centers of the dots 13a, 14a and 15a discharged from a same nozzle (e.g., the nozzle 11a) and a line y2 that joins the centers of the dots 13b, 14b and 15b discharged from an adjacent same nozzle (e.g., the nozzle 11b) is referred to as a dot-center interval Sp. The dot-center interval Sp corresponds to the pitch P1 of the nozzles in using the ink-jet head shown in FIGS. 3 and 4. As shown in FIG. 4, because the pitches P1 between the nozzles of the ink-jet head are equal in distance, the dot-center interval Sp between the line y1 and the line y2 is equal in distance to an adjacent dot-center interval Sp between the line y2 and the line y3.

If the alignment film composition can uniformly spread out on the substrate surface to cover uniformly, the alignment film has no nonuniform thickness; however, the dots of the alignment film composition discharged from the nozzles, such as the dots 13a, 13b and 13c, do not sometimes spread out perfectly in a direction of the adjacent dots (the aligned-nozzle direction), depending on the composition of the alignment film composition, or application conditions. In such a case, the dots 13a, 13b and 13c of the alignment film composition discharged respectively from the nozzles 11a, 11b and 11c are formed largest in thickness at locations immediately below the nozzles 11a, 11b and 11c of the ink-jet head 10, and formed smaller in thickness in the aligned-nozzle direction from the locations immediately below the nozzles 11, and formed smallest at locations below the midpoints between the aligned dots 13a, 13b and 13c. As shown in FIG. 3, the alignment film 8 in the aligned-nozzle direction has the shape of a string of equally located semicircles in cross section. It should be noted that the inventors of the present invention tracked down the cause of streaky display unevenness that develops along the discharging direction of the ink-jet head in the liquid crystal display element and found that the cause has relevance to the alignment film composition discharged onto the substrate surface in the case of having a nonuniform thickness in a direction of the adjacent dots. The reason of the development of the display unevenness in the liquid crystal display element that results from the nonuniform thickness of the alignment film is assumed as follows.

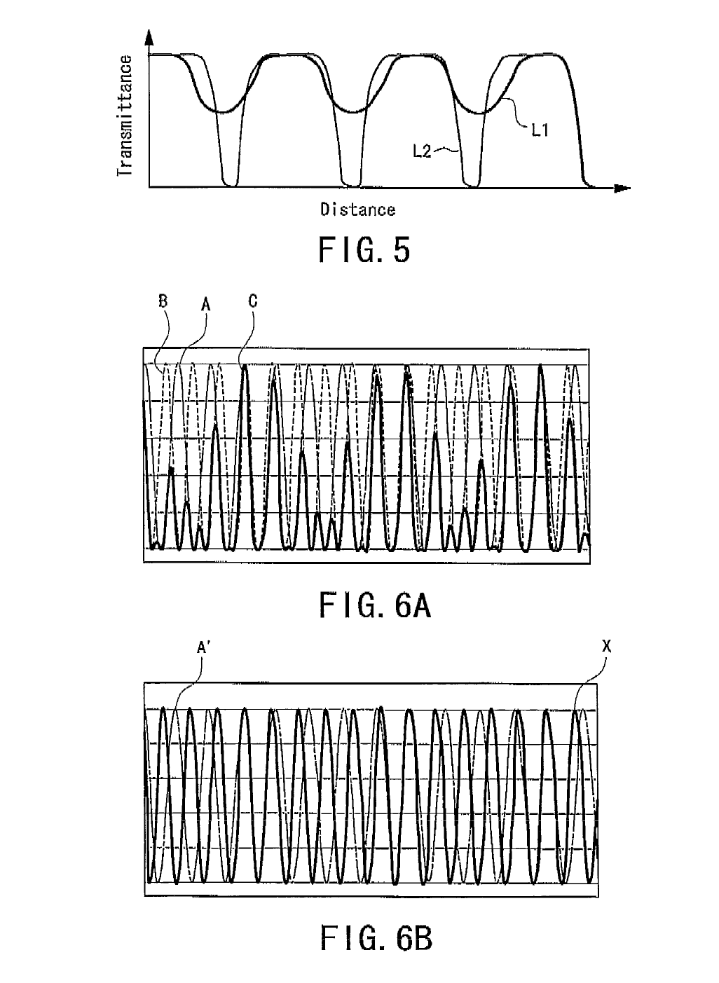

FIG. 5 is a graph showing transmittance of the array substrate 5 shown in FIG. 3. The vertical axis of the graph indicates the transmittance, and the horizontal axis indicates a distance from one end of the substrate in the aligned-nozzle direction of the ink-jet head. In FIG. 5, the curve L1 indicates the transmittance only of the alignment film 8 in the array substrate 5 shown in FIG. 3, and curves in accordance with the thickness of the alignment film 8 having the nonuniform thickness as shown in FIG. 3. The transmittance only of the alignment film 8 cyclically changes at the dot-center interval Sp. The transmittance only of the alignment film is expressed by the following formula (1):

transmittance only of the alignment film∝sin²(π·D/Sp) (1)

where D represents a distance from the one end of the substrate to the center of the dot 13 in the aligned-nozzle direction, and Sp represents the dot-center interval. Thus, the curve L1 shown in FIG. 5 curves cyclically at the dot-center interval Sp.

The array substrate 5 includes the scanning lines 51 aligned at a given interval and provided individually to the pixels. The scanning lines 51 define a light shielding layer arranged to transmit no light. In the liquid crystal display element 1, the portions other than the light shielding layer are designed as openings of the pixels through which light passes. The interval between the scanning lines 51 corresponds to an interval between the pixels in the vertical direction. When the substrate 4 includes only the scanning lines 51, the transmittance in the aligned-nozzle direction is the transmittance of the openings of the array substrate 5, and is indicated by the curve L2 shown in FIG. 5. The transmittance of the openings of the array substrate 5 is expressed by the following formula (2):

transmittance of the openings∝sin²(π·D/P2) (2)

where P2 represents an interval between the pixels. Thus, the curve L2 shown in FIG. 5 curves cyclically at the interval of the interval P2.

As shown in FIG. 4, the dot-center interval Sp (the pitch P1 between the nozzles) and the pixel interval P2 are usually not set to be same. Thus, in the curve L1 and the curve L2, the transmittance indicated by the curve L1 reaches its peak at a position different from a position at which the transmittance indicated by the curve L2 reaches its peak. The transmittance of the openings of the array substrate 5 is represented as a combination of the transmittance of the alignment film 8 and the transmittance of the openings provided with a shielding layer.

FIG. 6A is a graph showing a wave of superimposed two waves, one of which has a cycle equal to the dot-center interval Sp, and the other has a cycle equal to the pixel interval P2. As shown in FIG. 6A, when a wave A having a cycle equal to the dot-center interval Sp and a wave B having a cycle equal to the pixel interval P2 are superimposed to synthesize, the waves A and B interfere with each other because of the different cycles and become a synthesized wave C that cyclically changes in amplitude. The change in amplitude (wave height) of the synthesized wave C means that the actual transmittance of the display element is not held constant but cyclically changes between the pixel intervals in the aligned-nozzle direction. The actual transmittance of the pixels (openings) in the aligned-nozzle direction of the array substrate 5 has high wave portions and low wave portions that cyclically appear due to the interference, similarly to the synthesized wave C shown in FIG. 6A. Hence, the transmittance of the openings of the array substrate 5 changes at a given cycle due to the interference. The array substrate 5 looks bright at a portion of high transmittance, and dark at a portion of low transmittance. Consequently, in the array substrate 5, streaky bright and dark display unevenness develops along the discharging direction of the ink-jet head in the formation of the alignment film (the direction perpendicular to the aligned-nozzle direction).

The display unevenness is further emphasized in the stacked array substrate 5 and the color filter substrate 3 because of the reason stated below. The liquid crystal display element 1 has the configuration that the array substrate 5 and the color filter substrate 3 are stacked having the alignment films 7 and 8 opposed to each other as shown in FIG. 1. The color filter substrate 3 includes the black matrix 31 disposed at positions corresponding to the scanning lines 51 of the array substrate 5, and also includes the alignment film 7. The alignment film 7 of the color filter substrate 3 is usually formed with the use of the same device that is used in the formation of the alignment film 8 of the array substrate 5. In such a case, the alignment film 7 is formed on the color filter substrate 3 in the same manner as the alignment film 8 formed on the array substrate 5 with the use of the identical ink-jet head. The alignment film 7 of the color filter substrate 3 thus formed has a nonuniform thickness at the dot-center interval same as the alignment film 8. Hence, when the alignment films 7 and 8 each having a nonuniform thickness are stacked to produce a display element, the nonuniform thicknesses appear alike at locations corresponding to each other, so that wider change of transmittance occurs in the display element. Further, in the formation of the alignment films on the array substrate and the color filter substrate with the use of the identical ink-jet head including the nozzles aligned at the given pitch, display unevenness resulting from the interference between the cycle of the nonuniform thickness of the alignment film and the cycle of the pixel interval is sometimes increased.

In order to overcome the problems described above, the inventors of the present invention found that no streaky display unevenness develops in the display element if the display element is produced by combining the substrates in which one of the alignment films is formed by shifting the ink-jet head by half a dot-center interval to discharge and apply the alignment film composition onto the transparent substrate surface, where the dots of the alignment film compositions being aligned such that the dot-center interval between the lines on one of the alignment films is displaced by half a dot-center interval from the dot-center interval between the lines on the other alignment film. FIG. 6B is a graph showing a synthesized wave X that is obtained by superimposing a wave A′, which is obtained by displacing the wave A having the cycle equal to the dot-center interval Sp shown in FIG. 6A by half a cycle in the horizontal axis (the axis indicating the distance), on the synthesized wave C that is obtained by superimposing the wave A having the cycle equal to the dot-center interval Sp and the wave B having the cycle equal to the pixel interval P2. As shown in FIG. 6B, when the wave A′ obtained by displacing the wave A by half the cycle in the horizontal axis (the axis indicating the distance) is superimposed on the wave A having the cycle equal to the dot-center interval Sp, the waves A and A′ are cancelled out, and the synthesized wave X has the same waveform as the wave B having the cycle equal to the pixel interval P2. In other words, the synthesized wave X has the same waveform as the wave B having the cycle equal to the pixel interval P2 in the state of not being interfered by the wave A having the cycle equal to the dot-center interval Sp due to the nonuniform thickness of the alignment film.

Similarly to the graph shown in FIG. 6B, since the array substrate 5 and the color filter substrate 3 include the alignment films 7 and 8 that are formed under the same conditions except one condition that one of the alignment films 7 and 8 is formed such that a discharge starting position of the ink-jet head with respect to the substrate is shifted by half the dot-center interval in the aligned-nozzle direction, combining the array substrate 5 and the color filter substrate 3 including the alignment films 7 and 8 cancels the cyclical change of the nonuniform thicknesses of the alignment films 7 and 8. In the display element 1, because cyclical change of the transmittance curves indicating nonuniform thicknesses of the alignment films 7 and 8 is cancelled out even if the alignment films 7 and 8 have the nonuniform thicknesses, interference between cyclical change of the transmittance curve indicating transmittance of the openings of the pixels and cyclical change of the transmittance curves indicating nonuniform thickness of the alignment films 7 and 8 is eliminated. The elimination of the interference prevents streaky display unevenness that develops along the discharging direction of the ink-jet head. It is assumed that the configuration described above can achieve a liquid crystal display element with uniform display without display unevenness.

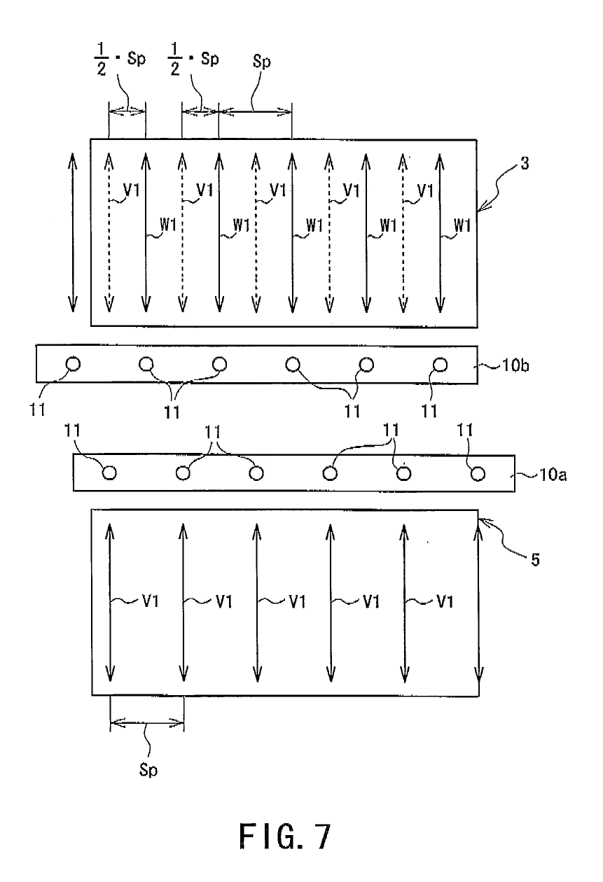

FIG. 7 is a plan view for illustrating the alignment film of the array substrate and the alignment film of the color filter substrate, which shows the substrates and the ink-jet head. Hereinafter, a description of a specific manner for applying the alignment film composition on the array substrate and the color filter substrate by the ink-jet method will be provided. As shown in FIG. 7, in the formation of the alignment film 8 on the surface of the array substrate 5, an ink-jet head 10a is used, and the ink-jet head 10a is moved above the array substrate 5 on which lines and other components are already formed, discharging the alignment film composition from the nozzles 11 onto the substrate surface. In FIG. 7, the straight lines V1 join the dots of the alignment film composition discharged onto the surface of the array substrate 5. Then, by subjecting the alignment film composition to the provisional dry treatment, the heat treatment, the photo-alignment processing and other treatments as described above, the alignment film 8 is formed. In this stage, the alignment film 8 of the array substrate 5 has a nonuniform thickness at the dot-center interval Sp as shown in FIG. 3.

Meanwhile, in the formation of the alignment film 7 on the surface of the color filter substrate 3, an ink-jet head 10b is used that includes nozzles 11 aligned at a pitch P1 same as the nozzles 11 of the ink-jet head 10a used in the formation of the alignment film 8 on the surface of the array substrate 5. The ink-jet head 10b may be identical to the ink-jet head 10a. The ink-jet head 10b is moved above the array substrate 5 from one end of the substrate 5 to the other end, on which the black matrix 31, the color filter 32, the common electrode 33 and other components are already formed, applying the alignment film composition on the substrate surface.

It should be noted that in the formation of the alignment film 7, a discharge starting position of the ink-jet head 10b is shifted by half a dot-center interval in the aligned-nozzle direction perpendicular to the discharging direction, and then the ink-jet head 10b is moved above the array substrate 5 from one end to the other end, discharging the alignment film composition onto the substrate surface. In FIG. 7, the straight lines W1 join the dots of the alignment film composition discharged onto the surface of the color filter substrate 3, and the dotted lines V1 indicate the corresponding straight lines V1 on the array substrate 5. Then, by subjecting the alignment film composition to the provisional dry treatment, the heat treatment, the photo-alignment processing and other treatments as described above, the alignment film 7 is formed. The alignment film 7 of the color filter substrate 3 has a nonuniform thickness at the same interval as the alignment film 8 of the array substrate 5 because the dot-center interval Sp is same. The nonuniform thickness of the alignment film 7 of the color filter substrate 3 is displaced by half the dot-center interval SP in the aligned-nozzle direction from the nonuniform thickness of the alignment film 8 of the array substrate 5.

In building the liquid crystal display element 1 by stacking the array substrate 5 and the color filter substrate 3, they are stacked such that the aligned-nozzle directions of the ink-jet heads in the formation of the alignment films 7 and 8 are in the same direction while the substrates 5 and 8 are aligned at their ends. In other words, in the step of the alignment, the substrates 3 and 5 are aligned in the same manner as conventional array substrate and color filter substrate. The substrates 3 and 5 are stacked while the dots of the alignment film compositions are aligned such that the dot-center interval between the lines on one of the alignment films is displaced by half the dot-center interval from the dot-center interval between the lines on the other alignment film.

The alignment films 7 and 8 in the liquid crystal display element 1 have a relation that the nonuniform thickness of one of the substrates (e.g., the array substrate 5) and the nonuniform thickness of the other substrate (e.g., the color filter substrate 3) cancel each other out, as shown in FIG. 1. When the nonuniform thicknesses of the substrates 7 and 8 are cancelled out in the liquid crystal display element 1, the change of transmittance due to the nonuniform thicknesses of the alignment films does not occur, which prevents display unevenness from developing in the display element 1.

It is essential only that the ink-jet head 10a and the ink-jet head 10b used in the alignment film formation should have the same nozzle pitch; however, it is preferable that the ink-jet head 10a and the ink-jet head 10b may be identical. This is because different ink-jet heads have individual differences and are subtly different from one another in a discharge amount of a composition, a nozzle position or other properties even if nozzles of the ink-jet heads are formed following the same specifications, and this malfunction can be solved by using the identical ink-jet head. To be specific, by forming two different alignment films using the identical ink-jet head while shifting the discharge starting position of the ink-jet head exactly by half the nozzle pitch, the dot-center intervals of the two different alignment films exactly agree with each other. Thus, forming the two different alignment films by using the identical ink-jet head solves the malfunction due to the individual differences of the ink-jet heads, and the alignment films can be formed with high precision, preventing the nonuniform thicknesses of the alignment films from being formed at different dot-center intervals.

It is preferable that the discharging direction of the ink-jet head 10 is parallel to the bus lines, and the bus lines are the scanning lines, because of the reason stated below.

It is assumed that if the nozzles of the ink-jet heads have individual differences, the formed alignment films 7 and 8 are not precisely displaced by half the dot-center interval because of the subtle displacement between the discharging positions of the nozzles of the ink-jet heads. The nonuniform thicknesses of the alignment films 7 and 8 that are formed using such ink-jet heads are not cancelled out completely, so that the influence of the nonuniform thicknesses can not be removed completely. In this case, if the black matrix is parallel to the data lines and the discharging direction of the ink-jet head 10 is made parallel to the data lines in the liquid crystal display element, spectral distribution of the color filter is multiplied by the uncancelled transmittance, and a colored streak is generated. Meanwhile, if the black matrix is parallel to the scanning lines and the discharging direction of the ink-jet head 10 is made parallel to the scanning lines in the liquid crystal display element, a colored streak can be prevented from being generated even if the alignment films are not formed with high precision.

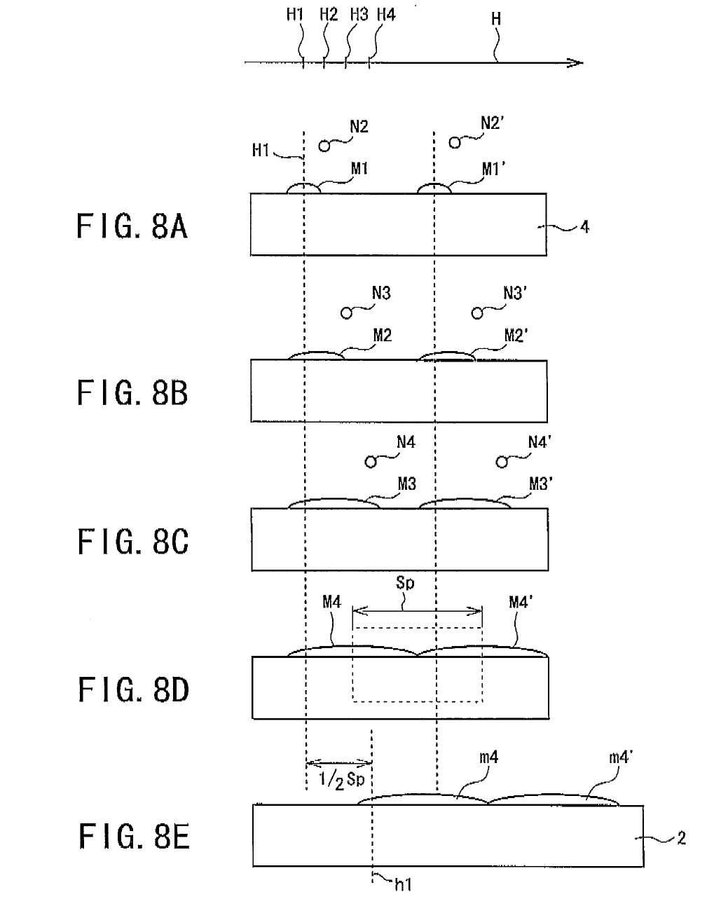

In the formation of the alignment film using the ink-jet method, it is also preferable that after the application of the alignment film composition by moving the ink-jet head in the discharging direction, the ink-jet head is shifted in the aligned-nozzle direction and then moved in the discharging direction through a different location above the substrate surface, and the alignment film composition is reapplied on the substrate surface. FIGS. 8A to 8E are views for illustrating a case of repeatedly applying the alignment film composition while shifting the ink-jet head in the aligned-nozzle direction. It should be noted that in FIGS. 8A to 8E, the nozzles are not shown while the application of the alignment film composition with the use of two nozzles is illustrated.

Hereinafter, a description of a manner for repeatedly applying the alignment film composition by shifting the ink-jet head in the aligned-nozzle direction will be provided. As shown in FIG. 8A, being moved in the discharging direction so that the nozzle is positioned at a location H1, the ink-jet head discharges the alignment film composition onto the surface of the substrate 4, and forms a dot M1 thereon. Then, after being shifted in the aligned-nozzle direction H, the ink-jet head is moved again in the discharging direction so that the nozzle is positioned at a location H2, and discharges a droplet N2 of the alignment film composition at the location H2. The droplet N2 reaches the substrate surface, overlaps with the dot M1 to spread out in the horizontal direction, and forms a dot M2 as shown in FIG. 8B. Then, after being shifted further in the aligned-nozzle direction H, the ink-jet head is moved again in the discharging direction, and discharges a droplet N3 of the alignment film composition at the location H3. The droplet N3 reaches the substrate surface, overlaps with the dot M2, and forms a dot M3 as shown in FIG. 8C. Then, after being shifted further in the aligned-nozzle direction H, the ink-jet head is moved again in the discharging direction, and discharges a droplet N4 of the alignment film composition at the location H4. The droplet N4 reaches the substrate surface, overlaps with the dot M3, and forms a dot M4 as shown in FIG. 8D. During this dot formation process, the alignment film composition is discharged also from the adjacent nozzle in a similar manner, and dots M1′ to M4′ are concurrently formed adjacent to M1 to M4, respectively. The interval between the centers of the dot M4 and M4′ thus formed defines a dot-center interval Sp.

In addition, shown in FIG. 8E is a case of applying the alignment film composition on the surface of the other transparent substrate 2. As shown in FIG. 8E, the ink-jet head having the same nozzle pitch as the ink-jet head used in discharging the alignment film composition onto the transparent substrate 4 is moved in the discharging direction so that the nozzle is positioned at a location h1 that is a location displaced by half a dot-center interval Sp from the location H1 and defined as a location corresponding to the location H1 in the aligned-nozzle direction H, and the ink-jet head discharges the alignment film composition onto the substrate surface. Then, the ink-jet head is shifted in the aligned-nozzle direction H up to the locations H2, H3, and H4 in succession while being moved repeatedly in the discharging direction, and the alignment film composition is reapplied on the substrate surface. Dots m4 and m4′ thus formed on the surface of the substrate 2 have shapes same as the dots M4 and M4′ respectively formed on the surface of the substrate 4, and are positioned at locations displaced by half the dot-center interval Sp from the dots M4 and M4′ in the aligned-nozzle direction.

In the manner illustrated in FIGS. 8A to 8E, the distances of the shifts of the ink-jet head (the distance between the locations H1 and H2, the distance between the locations H2 and H3, and the distance between the locations H3 and H4) are each set to be smaller than the dot-center interval Sp, and the alignment film composition is applied so as to fill the dot-center interval from the dot at the firstly discharged location to the dot discharged from the adjacent nozzle while the nozzles of the ink-jet head are moved in the discharging direction while being shifted in the aligned-nozzle direction between the dot-center interval on the substrate surface. It is to be noted that illustrated in FIGS. 8A to 8E is the manner for reapplying the composition four times; however, the present invention is not limited thereto, and the composition may be reapplied any times. For example, by repeating the shift in the aligned-nozzle direction and the movement in the discharging direction, further reapplication may be performed.

In the manner illustrated in FIGS. 8A to 8E, the composition is discharged in the order of the locations H1, H2, 113 and H4 in the aligned-nozzle direction; however, the present invention is not limited thereto.

In addition, the distances of the shifts of the ink-jet head are not limited to a distance smaller than the dot-center interval Sp. In a case where the substrate is longer than the ink-jet head in the aligned-nozzle direction, it is also preferable that the ink-jet head is shifted by the length of the ink-jet head in its longitudinal direction while being moved in the discharging direction above a portion of the substrate surface where the composition is yet to be applied, and the alignment film composition is applied on the unapplied portion of the substrate surface, which is not shown specifically.

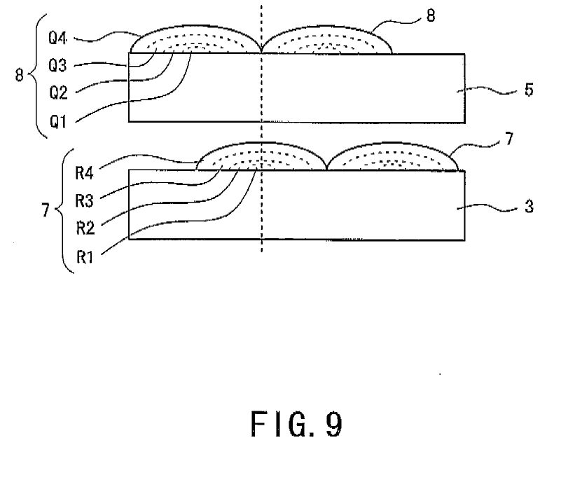

FIG. 9 is a view for illustrating a case of repeatedly applying the alignment film composition. As shown in FIG. 9, it is also preferable that the ink-jet head is moved in the discharging direction four times through a same location on the array substrate 5 without being shifted in the aligned-nozzle direction, the composition is applied thereon, forming a first application layer Q1, a second application layer Q2, a third application layer Q3, and a fourth application layer Q4 in succession, and the alignment film 8 is formed. In addition, the alignment film 7 is formed on the color filter 3 in a similar manner to the array substrate 5 such that the ink-jet head is moved in the discharging direction four times through a same location on the color filter substrate 3, the composition is applied thereon, forming a first application layer R1, a second application layer R2, a third application layer R3, and a fourth application layer R4 in succession, and the alignment film 7 is formed, except that the application layers are formed at the same location displaced by half the dot-center interval Spas shown in FIG. 9. The alignment film 7 formed on the color filter 3 has a layer thickness pattern same as the alignment film 8 formed on the array substrate 5 except that the dot-center interval is displaced.

It is to be noted that in performing the repeated application described above, the number of the movement of the ink-jet head in the discharging direction is not limited to four times, and can be set appropriately in accordance with an intended layer thickness of the alignment film. In addition, in performing the repeated application while shifting the ink-jet head in the aligned-nozzle direction as illustrated in FIGS. 8A to 8E, the repeated application may be combined with the repeated application at the same location described above.

It is to be noted that the discharging direction of the ink-jet head 10 described above is perpendicular to the aligned-nozzle direction as shown in FIGS. 3 and 4; however, in the preferred embodiments of the present invention, it is essential only that the discharging direction of the ink-jet head 10 should not be parallel to the aligned-nozzle direction. For example, the discharging direction of the ink-jet head 10 may be any direction other than the direction perpendicular to the aligned-nozzle direction if the discharging direction and the aligned-nozzle direction intersect with each other.

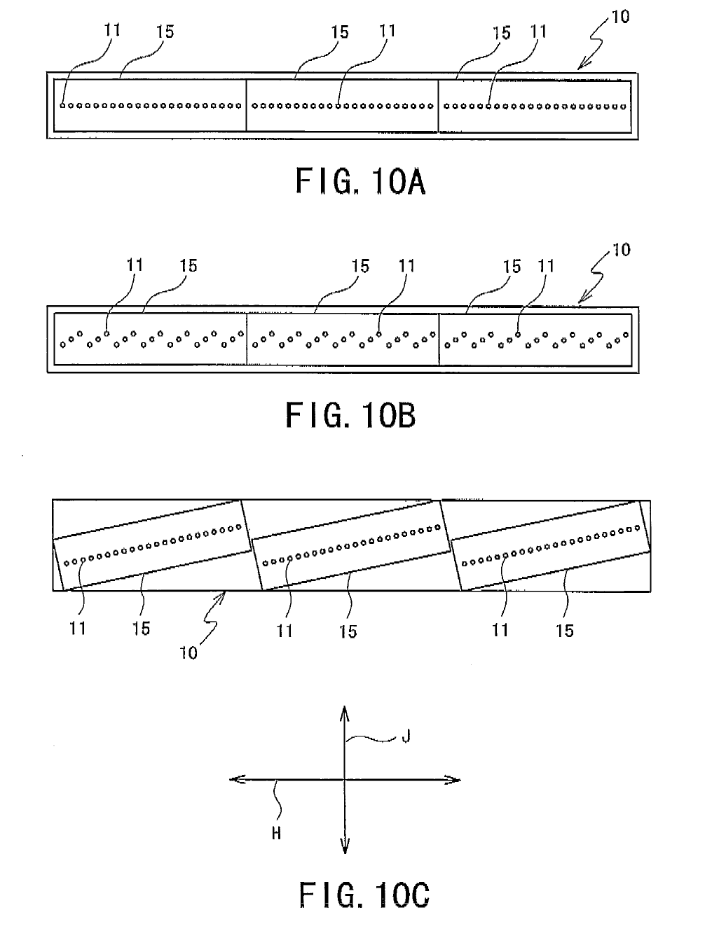

FIGS. 10A to 10C are plan views showing other embodiments of the ink-jet head. As shown in FIGS. 10A to 10C, the ink-jet head 10 may include head blocks 15 each including the nozzles 11, the head blocks 15 being connected with one another so as to be unitary. The head blocks 15 are connected with one another in the aligned-nozzle direction (indicated by the arrow H in FIGS. 10A to 10C). The discharging direction of the ink-jet head 10 (indicated by the arrow J in FIGS. 10A to 10C) is perpendicular to the aligned-nozzle direction H. In the ink-jet head 10 shown in FIG. 10A, the nozzles 11 of the head blocks 15 are aligned in the width direction of the head blocks 15.

The alignment of the nozzles 11 of the head blocks 15 in the ink-jet head 10 is not limited to the embodiment shown in FIG. 10A, and may be embodiments shown in FIGS. 10B and 10C. In the ink-jet head 10 shown in FIG. 10B, the nozzles 11 are grouped in three, and while each group is disposed oblique to the aligned-nozzle direction of the head blocks 15, the nozzles 11 are disposed in the aligned-nozzle direction H of the head blocks 15. In the ink-jet head 10 shown in FIG. 10C, each head block 15 includes the nozzles aligned in its longitudinal direction similar to the head blocks 15 shown in FIG. 10A, the head blocks 15 are each disposed oblique to the aligned-nozzle direction and connected with one other in the aligned-nozzle direction so as to be unitary. When the nozzles 11 are disposed oblique to the aligned-nozzle direction of the ink-jet head 10 as show in FIGS. 10B and 10C, the dot-center intervals can be made smaller even if the distances between the nozzles (nozzle pitch) are set to be same as the nozzles that are disposed not to be oblique.

The display element according to the preferred embodiments of the present invention can be favorably used for a liquid crystal display element; however, the use of the display element is not limited to the preferred embodiments of the present invention. For example, the following embodiments are included in the technical scope of the present invention.

(1) Described in the preferred embodiments of the present invention are the liquid crystal display element having the configuration that the alignment films are subjected to the photo-alignment processing, and the liquid crystal display element having the configuration that the ribs are provided to control the alignment of the liquid crystal molecules; however, the present invention includes a liquid crystal display element having a configuration such that alignment films are subjected to a rubbing processing to provide orientation on their surfaces by rubbing the alignment films a given number of times with the use of a cloth, a liquid crystal display element having a configuration such that a fringe electric field is used by providing electrode slits, and a liquid crystal display element having a configuration such that a liquid crystal having positive dielectric anisotropy is used.

(2) Described in the preferred embodiments of the present invention are a liquid crystal display element as an example of a display element, and an alignment film as an example of a thin film; however, the display element is not limited to the liquid crystal display element, and the thin film is not limited to the alignment film, and the present invention can be applied also to a display element if its thin film layers are formed by an ink-jet method.

(3) The present invention can be favorably applied especially to a display element having thin film layers large in size.

1-14. (canceled)

15. A display element comprising:
a first substrate comprising a first thin film layer comprising a thin film layer composition having the shape of dots aligned on straight lines; and
a second substrate comprising a second thin film layer comprising a thin film layer composition having the shape of dots aligned on straight lines, the second substrate being paired with the first substrate,
the dots on the first and second thin film layers being aligned such that an interval between the straight lines on one of the first and second thin film layers is displaced by half an interval from an interval between the straight lines on the other thin film layer.

16. The display element according to claim 15, wherein the thin film layer compositions are applied on the first and second thin film layers in an ink jet method.

17. The display element according to claim 15, wherein one of the first substrate and the second substrate comprises bus lines for matrix driving.

18. The display element according to claim 17, wherein the bus lines comprise the scanning lines.

19. The display element according to claim 15, wherein one of the first substrate and the second substrate comprises a black matrix.

20. The display element according to claim 15, wherein the first thin film layer and the second thin film layer each comprise an alignment film, and the first substrate and the second substrate are disposed having the alignment films opposed to each other.

21. The display element according to claim 20, wherein the alignment films each comprise a resin comprising a polyimide.

22. The display element according to claim 15, wherein one of the first and second substrates comprises an array substrate, and the other substrate comprises a color filter substrate.

23. The display element according to claim 15, wherein the display element comprises a liquid crystal display element that comprises a liquid crystal that is sealed in between the first and second substrates.

24. A method for producing a display element comprising a first substrate comprising a first thin film layer, and a second substrate comprising a second thin film layer, the method comprising the steps of:
forming the first thin film layer by applying a thin film layer composition having the shape of dots aligned on straight lines on a surface of the first substrate with the use of a first device that comprises a plurality of first nozzles aligned at a given pitch in an aligned-nozzle direction capable of discharging the composition at a time, while the first device is moved above the substrate in a direction in which the first nozzles discharge the composition;
forming the second thin film layer by applying a thin film layer composition having the shape of dots aligned on straight lines on a surface of the second substrate with the use of a second device that comprises a plurality of second nozzles aligned at a same pitch as the first nozzles in an aligned-nozzle direction capable of discharging the composition at a time, a discharge starting position of the second device being displaced by half an interval between the straight lines in the aligned-nozzle direction from a discharge starting position of the first device, while the second device is moved above the substrate in a direction in which the second nozzles discharge the composition; and
stacking the first substrate and the second substrate.

25. The method according to claim 24, wherein the steps of forming the first thin film layer and the second thin film layer each further comprise the steps of:
shifting the device in the aligned-nozzle direction after the application of the composition with the device moved in the discharging direction; and
moving the device above the substrate in the discharging direction through a location different from a location where the composition is already applied while reapplying the composition on the substrate surface.

26. The method according to claim 25, wherein a distance of the shift of each device is set to be smaller than the interval between the straight lines, and the steps of forming the first thin film layer and the second thin film layer each further comprise the step of shifting the device in the aligned-nozzle direction by the distance between the interval on the substrate surface after the application of the composition with the device moved in the discharging direction.

27. The method according to claim 24, wherein the steps of forming the first thin film layer and the second thin film layer each comprise the step of forming the thin film layer by applying the composition such that the dots on each straight line overlap each other while the device is moved in the discharging direction a plurality of times through a same location.

28. The method according to claim 24, wherein the discharging directions of the nozzles comprise directions perpendicular to the aligned-nozzle directions.

29. The method according to claim 24, wherein the first device and the second device are identical.

30. The method according to claim 24, wherein one of the first substrate and the second substrate comprises bus lines for matrix driving, and the steps of forming the one of the first thin film layer and the second thin film layer comprises the step of moving the device in a direction parallel to the bus lines.

31. The method according to claim 24, wherein the devices each comprise an ink-jet head for use in an ink-jet method.
